(19) United States
(12) Patent Application Publication
(10) Pub. No.: US 2005/0040205 A1
(43) Pub. Date: Feb. 24, 2005

(54) Buffered poppet valve member for pneumatic fastening tool

(76) Inventor: Harry M. Haytayan, Nashua, NH (US)

Correspondence Address: Nicholas A. Pandiscio;Pandiscio & Pandiscio, P.C., 470 Totten Pond Road, Waltham, MA, 02451-1914, US

(21) Appl. No.: 10/646,576

(22) Filed: Aug. 22, 2003

(51) Int. Cl. B25C 1/04

(52) U.S. Cl. 227/130

(57) ABSTRACT

A pneumatic fastening tool includes a piston reciprocally disposed in a cylinder, a hammer mounted on the piston for driving engagement with a fastener, and an improved poppet valve disposed at one end of the cylinder and operable to direct high pressure air to cause selected movement of the piston in the cylinder. The poppet valve includes a poppet valve casing having an inner surface, and a reciprocally movable poppet valve member having an end surface that confronts and repetitively engages the inner surface of the poppet valve casing. The poppet valve member end surface includes a portion thereof which is of a material more resilient than the inner surface of the poppet valve casing which it engages.

### BACKGROUND OF THE INVENTION

1. Field of the Invention

The invention relates to pneumatic fastening tools and is directed more particularly to an improvement in a poppet valve portion of such tools.

2. Description of the Prior Art

Pneumatic tools of the type described herein are generally known and are shown and described in U.S. Pat. No. 5,645,208, issued Jul. 8, 1997 to Harry M. Haytayan and U.S. Pat. No. 4,346,831, issued Aug. 31, 1982 to Harry M. Haytayan. Such tools typically comprise a housing, a cylinder mounted in the housing, a piston slidably disposed in the cylinder, a hammer connected to the piston, and selectively actuated operating means for causing the piston to reciprocate within the cylinder so as to drive the hammer from a retracted position to an extended position. The tools further include a nozzle section for receiving a fastener and positioning the fastener for engagement by the hammer to drive the fastener from the nozzle into a workpiece as the hammer is driven from the retracted position to the extended position. The operating means for causing the piston to reciprocate typically comprises a poppet valve that is operated by a manually-actuated trigger, and means responsive to operation of the poppet valve for selectively (a) applying high pressure gas to one side of the piston so as to urge the piston to move the hammer distally through the drive stroke or (b) relieving high pressure gas from the one side of the piston so as to permit the piston to move the hammer proximally through a return stroke.

The movement of the piston and hammer is actuated by a poppet valve member reciprocally movable in the aforesaid poppet valve. The movement of the valve member includes a dynamic engagement with one end of a poppet valve casing. While a resilient buffer member is mounted in the poppet valve casing and functions to absorb the thrust of the valve member, it has been found that the buffer member rapidly deteriorates, exposing the dynamically abutting valve member, buffer member, and valve casing end wall surface to premature wear and tear.

Accordingly, there is needed an improved buffering means in the poppet valve for facilitating a relatively “soft” engagement between the poppet valve member and the poppet valve casing end wall.

With the above and other objects in view, a feature of the invention is the provision of a pneumatic fastening tool comprising a piston reciprocally disposed in a cylinder, a hammer mounted on the piston for driving engagement with a fastener, and a poppet valve disposed at one end of the cylinder and operable to direct high pressure air to cause selected movement of the piston in the cylinder. The poppet valve includes the poppet valve casing and the reciprocally moveable poppet valve member therein, the poppet valve member having a proximal end surface opposed to a metal end surface of the poppet valve casing. The poppet valve member end surface includes a portion thereof which is made of a material more resilient than the poppet valve casing metal end surface.

The above and other features of the invention, including various novel details of construction and combinations of parts, will now be more particularly described with reference to the accompanying drawings and pointed out in the claims. It will be understood that the particular devices embodying the invention are shown by way of illustration only and not as limitations of the invention. The principles and features of this invention may be employed in various and numerous embodiments without departing from the scope of the invention.

### BRIEF DESCRIPTION OF THE DRAWINGS

Reference is made to the accompanying drawings in which are shown illustrative embodiments of the invention from which its novel features and advantages will be apparent.

In the drawings:

FIG. 1 is a sectional view of a prior art pneumatic fastening tool;

FIG. 1A is an enlarged sectional view of a portion of the tool shown in FIG. 1;

FIG. 2 is a top plan view of a poppet valve member illustrative in part of an embodiment of the invention;

FIG. 3 is a sectional view taken along line III-III of FIG. 2;

FIG. 4 is a top plan view similar to FIG. 2, but showing an element fixed to the poppet valve member of FIGS. 2 and 3;

FIG. 5 in a sectional view taken along line V-V of FIG. 4;

FIG. 6 is a top plan view of an alternative poppet valve member illustrative in part of an alternative embodiment of the invention;

FIG. 7 is a sectional view taken along line VII-VII of FIG. 6;

FIG. 8 is a top plan view similar to FIG. 6, but showing an element fixed to the poppet valve member of FIGS. 6 and 7; and

FIG. 9 is a sectional view taken along line IX-IX of FIG. 8.; and

FIGS. 10 and 11 are views similar to FIGS. 8 and 9 of another embodiment of the invention.

In the several figures like numerals are used to indicate like parts.

### DESCRIPTION OF THE PREFERRED EMBODIMENTS

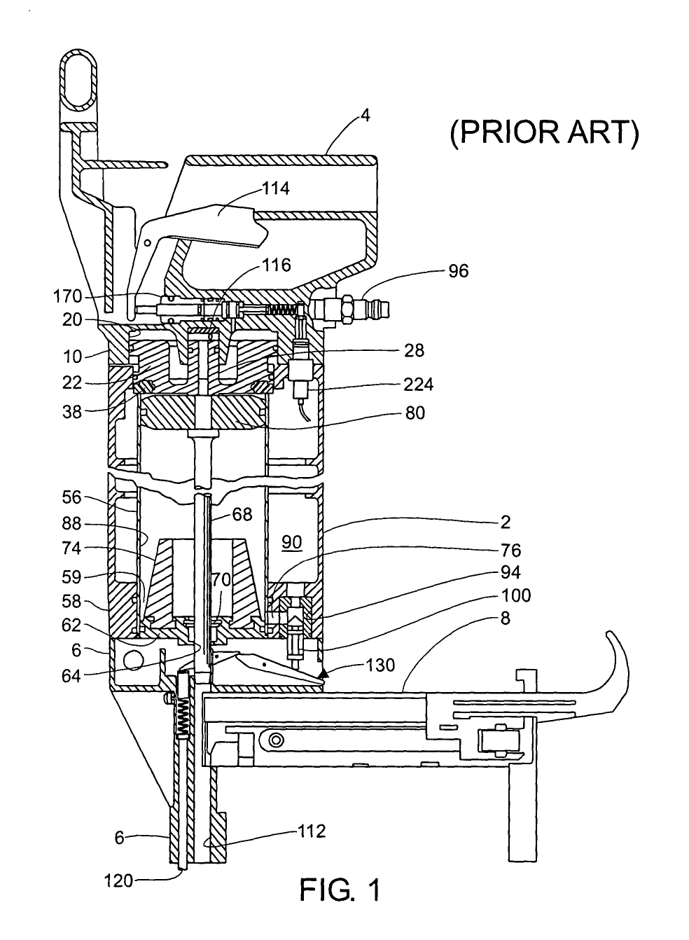

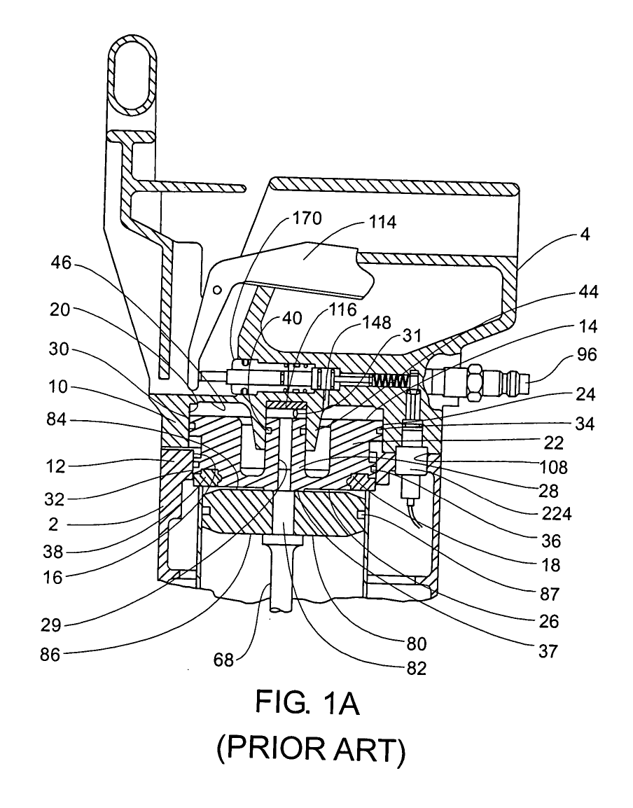

Referring to FIGS. 1 and 1A, it will be seen that the illustrative pneumatic fastening tool includes an outer housing 2, the proximal and distal ends of which are closed off by a handle member 4 and a nozzle member 6, respectively. The nozzle member 6 includes a magazine 8 which accommodates one or more clips of fasteners (not shown) that consist of a strip of plastic sleeves, each holding a fastener, such as those shown and described in the '831 patent cited hereinabove and incorporated herein by reference. The handle member 4 and nozzle member 6 are removably secured to the housing 2 by suitable screw fasteners (not shown).

The outer housing 2 is formed with an end wall 12 (FIGS. 1A) at its proximal (top) end. The end wall 12 defines a cylindrical opening 16 which coacts with a cylindrical cavity 20 in the handle member 4 to define a poppet valve casing 10 which slidably accommodates a poppet valve member 22. The poppet valve member 22 comprises a circumferentially extending cylindrical side wall 24, a transversely extending distal end wall 26 formed integrally with the side wall 24, a proximal end surface 14, and a center post 28 formed integrally with the distal end wall 26 and extending proximally. The side wall 24 comprises two axially spaced sections 30, 32 having cylindrical outer surfaces of larger and smaller diameters respectively that are provided with circumferentially-extending grooves in which O-ring seals 34 and 36, respectively, are disposed. The seals 34 and 36 each make a fluid-tight sliding engagement with the adjacent inner cylindrical surfaces of the poppet valve casing 10. The center post 28 is provided with a central axial passageway 29 that communicates with a radial port 31 which is used to vent air from between the poppet valve member 22 and a piston 80. The proximal end surface 14 of the poppet valve member 22 has a larger effective area than the distal end wall 26.

The end wall 26 of poppet valve member 22 is provided with a distal end face 37 formed with a peripheral recess 18 in which is molded and captivated a resilient annular sealing member 38 that preferably is made of a suitable natural or synthetic rubber or plastic material, such as a silicone rubber. The bottom face of the sealing member 38 is flat so that the sealing member 38 can make a full and tight seal with a flat upper end surface of a cylinder 56 (FIG. 1) disposed inside the outer housing 2. The outer diameter of the distal end wall 26 of the poppet valve member 22 is sized slightly greater than the outer diameter of the cylinder 56, so that a small portion of the poppet valve member end face 37 and sealing member 38 projects radially outwardly of the cylinder 56, as shown.

The center post 28 of the poppet valve member 22 is provided with a groove to accommodate a sealing member in the form of a resilient O-ring 40 (FIG. 1A) that makes an hermetic sliding seal with a surrounding internal cylindrical surface of a downwardly projecting exhaust valve casing 44 that is formed integrally with the handle member 4. The valve casing 44 includes a radial port 31 and the latter communicates with the atmosphere exterior of the tool via a vent port (not shown) in the handle member 4.

Set within the outer housing 2 is the hollow cylinder 56, which is hermetically secured at its distal end in an opening 59 in a distal end wall 58 of the outer housing 2. The cylinder 56 is positioned so that the end sealing member 38 of the poppet valve member 22 forms a tight seal with the proximal end of the cylinder 56 when the poppet valve member 22 is in its distal-most position. The cylinder 56 is spaced from the interior surface of the outer housing 2 so as to form a chamber 90 which serves as an air reservoir. The chamber 90 communicates with the open proximal end of the cylinder 56 when the poppet valve member 22 is moved out of engagement with the cylinder.

The distal end 58 of the cylinder 56 is closed off by a circular cap 62. A central circular bore 64 formed in the cap 62 accommodates a hammer 68 fixed to the piston 80. The circular bore 64 is fitted with an annular sealing assembly 70 that surrounds and engages the hammer 68 with sufficient force to prevent leakage of fluid therebetween, while allowing the hammer to reciprocate axially. A resilient annular cushion member 74 is attached to the cap 62 and extends proximally in the cylinder 56 so as to act as a bumper for the piston 80 as the piston undergoes a work stroke. The distal end of the cylinder 56 has at least two side ports (one, 76 shown in FIG. 1) that permit ingress and egress of pressurized air.

Referring to FIG. 1A, a proximal end 82 of the hammer 68 is attached to the piston 80, which is provided with flat proximal and distal end surfaces 84, 86 and is sized to make a close sliding fit with the interior surface of the cylinder 56. The piston 80 has a peripheral groove which holds a sealing ring 87 that engages an interior surface 88 of the cylinder 56 so as to prevent leakage of fluid between the piston 80 and the surrounding cylinder 56 while allowing the piston to move axially within the cylinder.

Referring still to FIGS. 1 and 1A, the distal end wall 58 of the outer housing 2 has an opening 94 that extends parallel to and is spaced radially from the opening 59. The opening 94 accommodates a safety valve 100 that is actuated by a spring-biased safety rod 120 operating through a mechanical linkage identified generally by the numeral 130. Further details of construction of valve 100, rod 120 and linkage 130 are described in my aforesaid U.S. Pat. No. 5,645,208 which is incorporated herein by reference.

A trigger 114 pivotally mounted to handle 4 functions to operate a control valve identified generally by the numeral 170 that forms part of the handle assembly. Associated with control valve 170 is an air supply assembly 96 that is mounted in an opening in handle 2. Associated with control valve. 170 is a pneumatically operated mechanical interlock assembly identified generally at 224 that is mounted in an opening 108 in outer housing 2. Opening 108 extends parallel to the housing cylindrical opening 16. The interlock assembly is connected by means (not shown) to the lower end of cylinder 56, whereby it is responsive to the air pressure in the bottom end of the cylinder and is pneumatically disposed to mechanically block operation of control valve 170 by trigger 114, with the result that air pressure will keep the poppet valve in its down position against the top end of cylinder 56. A more detailed description of control valve 170, interlock assembly 224 and their pneumatic connections is provided in the above-cited U.S. Pat. No. 5,645,208.

The nozzle member 6 is provided with a circular bore 112 that is aligned with the circular bore 64 of the plug 62 and with the hammer 68. The bore 112 is sized so that the hammer 68 will make a close sliding fit therein when the hammer is extended during a fastener-driving stroke. The bore 112 also serves to accommodate a fastener (not shown) fed by the magazine 8, so that when the hammer 68 is driven distally the fastener in the bore 112 will be engaged and driven by the hammer into a workpiece (not shown).

Operation of the tool is described in detail in the aforesaid '208 patent. However, for the purposes of the present invention, it suffices to note that high pressure air is admitted by way of supply assembly 96 into the reservoir chamber 90. The high pressure air in the chamber 90 flows through the safety valve 100 into the cylinder 56 distally of the piston 80. High pressure air also causes the interlock assembly 224 to block operation of control valve 170 by trigger 114, with the result that the poppet valve is in its closed (down) position, and piston 80 is forced upward to its proximal-most position so that the hammer 68 is in a raised position ready to drive a fastener that is fed from the magazine 8 into the bore 112 immediately below the hammer.

When the nozzle member 6 is pressed against a workpiece, safety rod 120 is forced inwardly of the tool, causing linkage 130 to cause safety valve 100 to change states, with the result that high pressure air is vented from cylinder 56 below the piston 80, thereby establishing a condition that permits rapid acceleration of the piston 80 and the hammer 68 when subsequently the poppet valve is actuated.

If thereafter trigger 114 is depressed so as to pivot counterclockwise (as viewed in FIGS. 1 and 1A), the poppet valve member 22 immediately moves proximally, thereby blocking exhaust port 31 and allowing high pressure air to enter the proximal (upper) end of the cylinder 56 from chamber 90 and forcing the piston 80 in a distal direction so as to cause the hammer 68 to engage a fastener in the bore 112 and drive the fastener out of the bore into a workpiece.

In its proximally directed movement, the poppet valve member center post 28 dynamically engages a resilient buffer member 116 disposed against a proximal end wall 46 of poppet valve casing 10, the buffer member 116 thereby absorbing the very pronounced impact of the center post 28. The buffer member 116 accordingly experiences the punishing wear and tear referred to hereinabove. The deterioration of buffer member 116 may become so severe as to result in portions thereof partially or totally blocking the radial vent port 31, thereby impeding venting of air as required for proper operation of the tool.

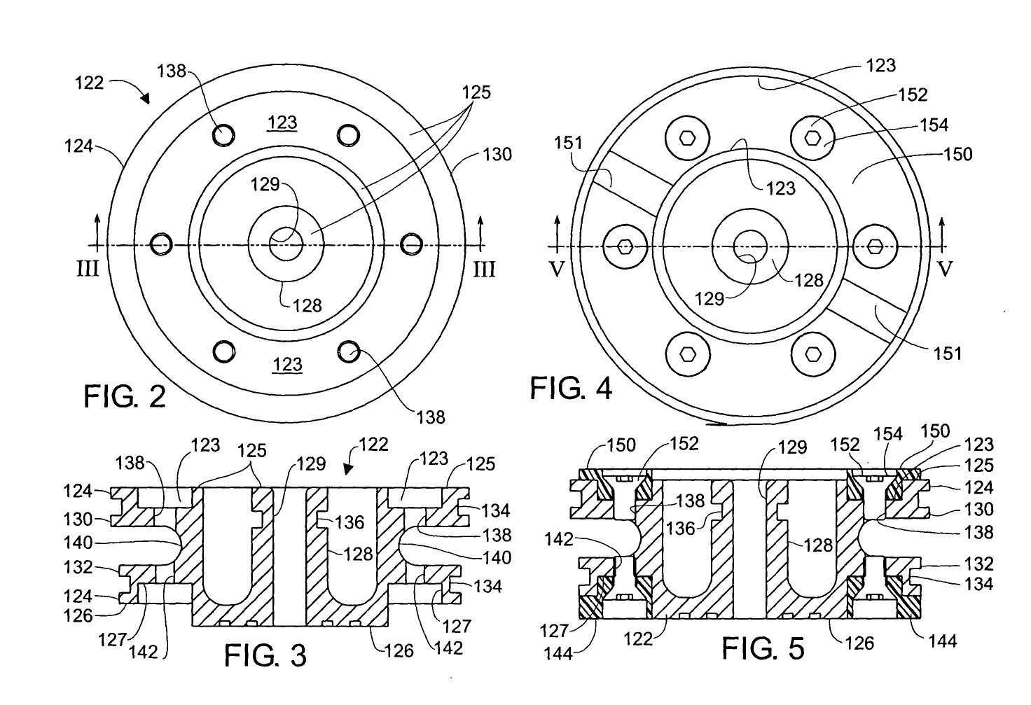

In order to rectify the problem, there is provided an improved poppet valve member 122, shown in FIGS. 2 and 3. The poppet valve member 122 includes an annular groove 123 in a proximal (top) surface 125 thereof, a side wall 124, including axially spaced radially-projecting sections 130 and 132 of different diameters, a distal (bottom) end wall 126, and a center post 128 having an axial passageway 129 extending therethrough. Each side wall section 130,132 is provided with an annular groove 134 for O-rings (not shown) like O-rings 34 and 36 (FIGS. 1A). Similarly center post 128 is provided with a groove 136 for receiving an O-ring ling O-ring 40 (FIG. 1A).

The distal end wall 126 is provided with an annular groove 127 generally aligned with the proximal end wall annular groove 123. A series of threaded holes 138 are provided that intersect groove 123. Similarly a series of holes 142 are provided that intersect annular groove 127 in the proximal direction to the peripheral annular slot 140. The holes 138 and holes 142 need not be aligned with each other.

Referring to FIGS. 4 and 5, a buffer ring 150 of non-metallic material more resilient than the metal (typically steel) of the poppet valve casing end wall 46 is fixed in the proximal annular groove 123. Buffer ring 150 is configured to receive a plurality of screw fasteners 152, such that the flat heads 154 of the screws are sunken well below the surface of the ring 150. Ring 150 projects above the level of the top end surface 125 of the poppet valve member as shown. Ring 150 has one or more, preferably at least two) shallow slots 151 in its upper surface. Preferably the bottoms of the slots are above the level of the upper surface 125 of the poppet valve member. Slots 151 are designed to facilitate escape of air via an air vent 148 (FIG. 1A) when the poppet valve is urged upwardly. On the distal end of poppet valve member 122, a sealing member 144 (FIG. 5) is secured in groove 127 by screw fasteners 154 in the same manner as the ring 150. The bottom surface of sealing member 144 is flat as shown to assure uniform contact with the upper end of cylinder 56. The bottom surface of sealing member 144 is even with the bottom end surface of the poppet valve member, but it may also project below that end surface.

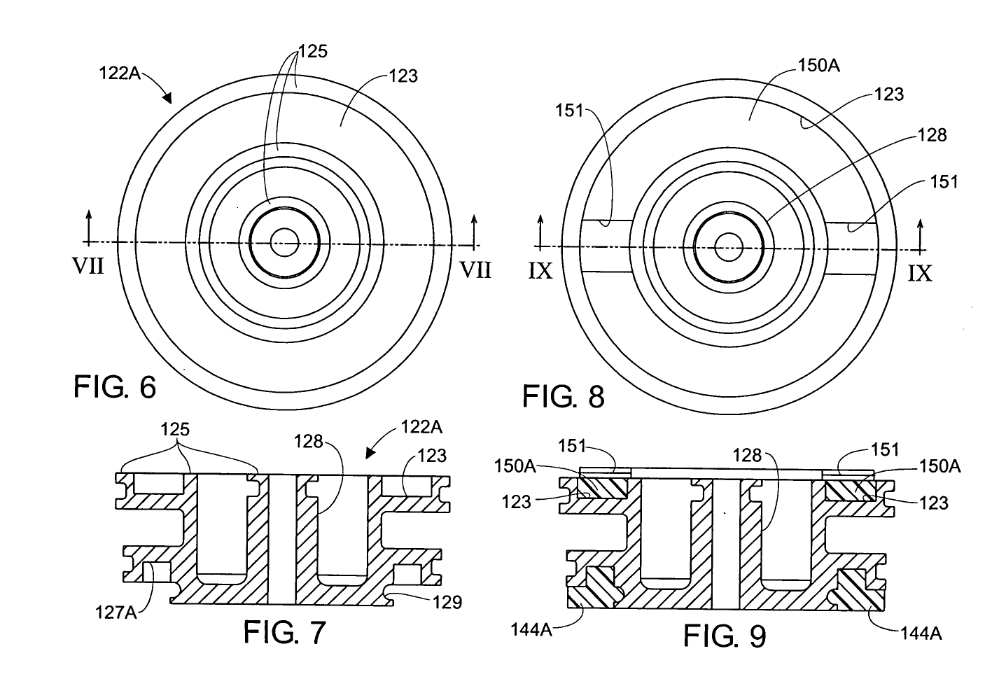

Referring to FIGS. 6-9, it will be seen that in an alternative embodiment, the holes 138 and 142 are omitted from the poppet valve member 122A and a buffer ring 150A is molded directly in the annular groove 123. Ring 150A projects above the level of the top end surface of the poppet valve member and has a pair of shallow slots 151 in its top surface, as shown. The distal portion of the poppet valve member includes a groove 127A and also a peripheral groove 129, and a sealing ring 144A is molded directly into grooves 127A and 129. Just as with the embodiment of FIG. 5, the sealing ring 144A has a flat bottom surface that preferably is flush with but may project below the bottom surface of the poppet valve member.

In either of the FIG. 5 and FIG. 9 embodiments, the buffer rings 150 and 150A are made of a material that is more resilient than the poppet valve casing end wall metal surface 46 which is confronted by the valve member proximal surface 125, e.g., a natural or synthetic rubber composition or a plastic material with elastomer or near-elastomer properties. The sealing rings 144 and 144A may be made of a natural or synthetic rubber or a plastic. Preferably rings 144 and 144A are made of a material that is harder (less resilient) than the material used for rings 150 and 150A, so as to assure good sealing contact with the cylinder 56.. The ring 150, and 150A preferably are made of a material with a hardness value of about 60 on the Durometer A scale, e.g. a ring of that hardness made of polyethylene, while the rings 144 and 144A preferably are made of a material having a hardness value of about 95 on the Durometer the A scale, e.g., a ring of that hardness made of polyurethane. The poppet valve member 122 or 122A typically is made of aluminum to facilitate faster operation of the tool. However, it may be made of some other material, e.g., magnesium or Delrin®. The extent to which rings 150 and 150A protrude above the upper end surface of the poppet valve member is set so as to permit operation as described in the following paragraph.

In operation, when the poppet valve member 122 or 122A moves up away from the top end of cylinder 56, the free end of the center post 28 contacts the resilient buffer member 116 at about the same time as the buffer ring 150 or 150a contacts the poppet valve casing end wall 46. Most of the impact is absorbed by the annular buffer ring 150 or 150a, due to the latter having a substantially greater surface area and volume for absorption of impact energy. Consequently the above-described arrangement essentially eliminates the problem of quick deterioration of the buffer member 116.

There is thus provided an improved buffering structure for a pneumatic fastening tool poppet valve member, facilitating a relatively compatible and less destructive engagement between the poppet valve member and the poppet valve casing end wall.

It will be apparent that while the rings 150,150A may be as described above and shown in the drawings, other fastened or molded elements of other configurations may be used, such as interrupted rings, spaced elements, and the like. For example, the rings may consist of two half rings. It also is contemplated that the top rings 150 and 150A may comprise a metal ring with spaced inserts of a material with acceptable properties for functioning as intended, e.g., an elastomer or a plastic as described above. Also the rings 150, 150A, 144 and 144A may be made of a variety of non-metallic materials. For example, the buffer rings 150 and 150A could be made of Delrin® or polyurethane and the rings 144 and 144A could be made of polypropylene or some other polymer material of suitable durometer. Also it is contemplated that the poppet valve member may combine a molded-in-place sealing ring and a top ring held in place by fasteners, or a molded in place top ring and a bottom sealing ring held in place by fasteners. Also it is contemplated that the top or bottom rings may be preformed and then secured in place by a suitable adhesive.

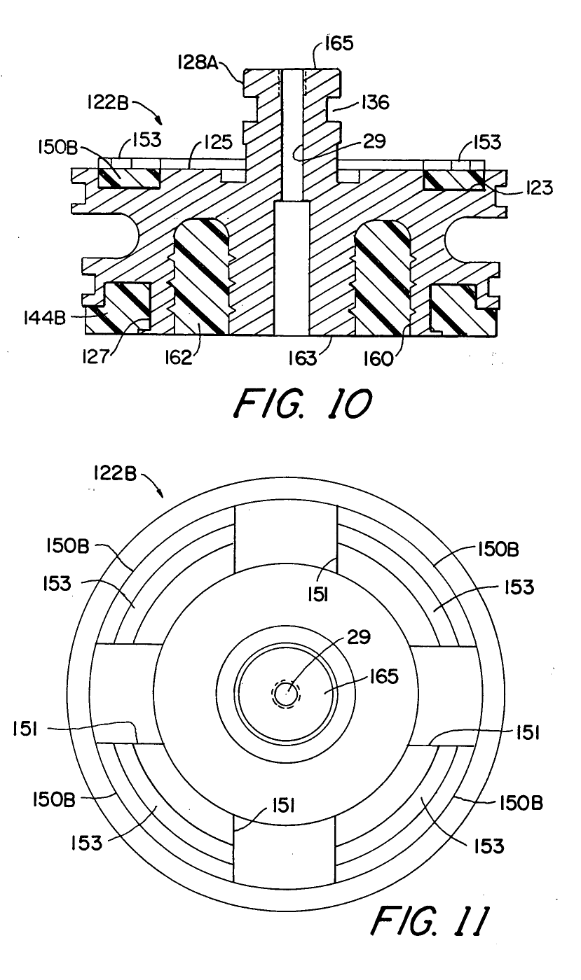

FIGS. 10 and 11 illustrate a modification of the invention in the form of a poppet valve member that is designed for use in a tool of like purpose that differs from the tool of FIG. 1 in that the downwardly projecting vent valve casing 44 is omitted and instead the post of the poppet valve is slidably received in a cylindrical recess formed in a flat end wall that forms part of the handle assembly or of the housing. Such an arrangement is shown in my U.S. Pat. No. 4,253,598, issued March 3,1981, which is incorporated herein by reference. In such case the poppet valve member is deemed to be of the “long neck” type because the center post projects a substantial distance above the upper end of the poppet valve member.

More particularly, the alternative embodiment shown in FIGS. 10 and 11 comprises a poppet valve member 122B having a buffer ring 150B and a sealing ring 144B molded in place in grooves 123 and 127 respectively. In this case the center post 128A is formed as cylindrical projection that extends a substantial distance above the top end surface 125 of the poppet valve member, with O-ring groove 136 also being located above the level of end surface 125. In this case the upper side of buffer ring 150B is formed with four equally spaced radial grooves 151 that are intersected and connected by arcuate grooves 153 of like depth. The number of radial grooves 151 is not critical and may be varied, but they must be connected by grooves like arcuate grooves 153. Connecting the radial grooves 151 with arcuate grooves 153 assures that air will be vented from above the poppet valve member. By way of example and with reference to my U.S. Pat. No. 4,253,598, cited supra,.assuming that the poppet valve member shown in FIGS. 10 and 11 is installed in the tool shown in that patent, the aforesaid groove pattern in the upper side of buffer ring 150B will assure that air will be vented from the chamber 68 shown in FIG. I of my U.S. Pat. No. 4,253,598 cited supra regardless of the rotational position of the poppet valve member relative to the vent port that connects chamber 68 to a conduit 70 that leads a valve that controls venting to the outside atmosphere.

The embodiment of FIGS. 10 and 11 also differs from the other embodiments herein disclosed in that it is formed with an annual groove 160 to reduce its weight. Groove 160 is filled with a light weight material 162, e.g. a polyurethane, so as that on its bottom side the poppet valve member presents a flat circular surface to the cylinder 56. However, this feature is a preferred, but not essential, feature of the invention.

Buffer ring 150B and sealing ring 144B are made of materials of suitable properties, as described above in connection with rings 150, 150A, 144 and 144A. The extent to which buffer ring 150B protrudes above the level of the upper surface of poppet valve member 122B is set so that it will contact the end wall that forms part of the handle assembly or of the tool housing at the same time that the upper end furface 165 of post 128A engages the resilient buffer member (corresponding to buffer member 116) that is provided at the upper end of the cylindrical recess in which the post reciprocates and which serves as a vent valve casing.

It will be understood that additional changes in the details, materials, and arrangement of parts, which have been herein described and illustrated in order to explain the nature of the invention, may be made by those skilled in the art within the principles and scope of the invention as expressed in the appended claims.

1. A pneumatic fastening tool comprising:
a piston reciprocally disposed in a cylinder;
a hammer mounted on said piston for driving engagement with a fastener device; and
a poppet valve disposed at one end of the cylinder and operable to direct high pressure air to cause selected movement of said piston in the cylinder;
said tool comprising means defining a vent valve casing and a inner surface surrounding said vent valve casing;
said poppet valve comprising a poppet valve member disposed between said surface and said cylinder and movable into and out of engagement with said one end of said cylinder, said poppet valve member including a proximal end surface in confronting relation with said inner surface, a vent valve member in the form of a post that is reciprocally movable in said vent valve casing; and a buffer means made of a material more resilient than said inner surface fixed to said proximal end surface.

2. The tool in accordance with claim 1 wherein said buffer means is molded to the poppet valve member.

3. The tool in accordance with claim 1 wherein said buffer means is fixed to the poppet valve member by fastener members.

4. The tool in accordance with claim 1 wherein said buffer means comprises an annular ring fixed to the poppet valve member by molding of the ring onto the poppet valve member.

5. The tool in accordance with claim 1 wherein said buffer means comprises an annular ring fixed to the poppet valve member by fastener members.

6. The tool in accordance with claim 1 wherein said inner surface is made of metal and said buffer means comprises a polymer.

7. The tool in accordance with claim 6 wherein the metal comprises steel and the more resilient material comprises polyethylene.

8. The tool in accordance with claim 1 wherein said buffer means comprises a polymer with a hardness of about 95 durometer measured on the A scale.

9. The tool in accordance with claim 4 wherein said annular ring is provided with at least one groove on an exposed surface thereof.

10. The tool in accordance with claim 5 wherein said annular ring is provided with at least one groove on an exposed surface thereof.

11. The tool in accordance with claim 1 wherein said poppet valve member has a distal end surface having an elastomeric element fixed thereto.

12. The tool in accordance with claim 11 wherein the elastomeric element is molded onto the poppet valve member second end surface.

13. The tool in accordance with claim 11 wherein the elastomeric element is fixed to the poppet valve member second end surface by fasteners.

14. The tool in accordance with claim 11 wherein the elastomeric element comprises polyurethane.

15. The tool in accordance with claim 2 wherein the poppet valve member includes a center post having a free end, and said poppet valve casing end surface is provided with a resilient buffer member fixed thereto such that the center post free end is engageable with the poppet valve casing resilient buffer member, and wherein said element is adapted to engage portions of said poppet valve casing end surface substantially simultaneously with the center post free end engagement with the resilient buffer member.

16. The tool in accordance with claim 15 wherein the element extends further proximally than the center post free end.

17. The tool in accordance with claim 15 wherein the center post extends further proximally than said element.

18. A poppet valve member adapted for reciprocal movement relative to a cylinder and a vent valve casing, said valve member comprising:
distal and proximal ends;
first and second annular grooves formed in said distal and proximal ends respectively; and
a resilient sealing ring secured in said first groove and a buffer ring of greater durometer than said first ring secured in said second groove.

19. A poppet valve member in accordance with claim 18 wherein said valve member is made of aluminum, magnesium or Delrin® and said rings are made of a polymeric material.

20. A poppet valve member in accordance with claim 18 wherein said rings are secured in said grooves by molding them in said grooves or by means of fasteners.

21. A poppet valve member in accordance with claim 18 further including first and second peripheral grooves located adjacent said distal and proximal ends for accommodating O-rings for forming a sliding seal with a surrounding poppet valve casing

22. A poppet valve member in accordance with claim 18 having an end wall at said distal end, a center post formed integral with said end wall and extending axially toward said distal end, said post having an internal passageway that extends for its full length, and said buffer ring extending proximally further than said center post.

23. A poppet valve member in accordance with claim 18 including an integral center post extending axially away from said distal end and projecting outwardly from said proximal end, said poppet valve member having an internal passageway that extends within and for the full length of said center post, and said post extending proximally further than said buffer ring.
